(19) United States
(12) Patent Application Publication
(10) Pub. No.: US 2022/0374518 A1
(43) Pub. Date: Nov. 24, 2022

(54) LOCAL FILE SECURITY

(71) Applicant: Focus Universal Inc., Ontario, CA (US)

(72) Inventor: Desheng Wang, Diamond Bar, CA (US)

(21) Appl. No.: 17/748,763

(22) Filed: May 19, 2022

Related U.S. Application Data
(60) Provisional application No. 63/190,604, filed on May 19, 2021.

(51) Int. Cl. G06F 21/56; G06F 21/54; G06F 21/55; G06F 21/57

(52) U.S. Cl. CPC G06F 21/565; G06F 21/54; G06F 21/554; G06F 21/572

(57) ABSTRACT

Disclosed is a system and method for increased security of files stored on local machines. The system and method include a number of checks to ensure that the file is being opened on the local machine where it was created. The checks may include a comparison to a CPUID of the machine on which the file is being opened to a CPUID stored in a script when the file was created. The checks may also include a review of a plurality of memory locations in search of artifacts indicating that the file is being opened on a virtual machine. A server may also check that any messages send from the local machine do not pass through an intermediate server.

### CROSS-REFERENCE TO RELATED APPLICATIONS

The present application claims the benefit of priority to U.S. Provisional Patent Application No. 63/190,604, filed May 19, 2021, the disclosure of which is hereby incorporated by reference in its entirety. Any and all applications for which a foreign or domestic priority claim is identified in the Application Data Sheet as filed with the present application are hereby incorporated by reference under 37 CFR 1.57.

### FIELD

The present invention relates to local file security.

### BACKGROUND

Theft of intellectual property is a growing area of concern. A more mobile work force means that employees may move between competitors more regularly than in the past. When the employee changes employment, the employees may either unknowingly or knowingly take intellectual property belonging to the company with them to a competitor. Such misappropriation of intellectual property is often the result of files removed from a local machine or a server, or the removal of an entire computer system, for example, a laptop. In some cases, the competitor may even be an extra-territorial competitor who believes that the use of the intellectual property will not be pursued because of the difficulty caused by having to pursue claims in another country or jurisdiction.

Computer files are more easily opened and used worldwide than ever before. If the misappropriation of files is accomplished by taking the hardware, for example, a laptop computer, then the applications which open the files are nearly essentially guaranteed to be present. However, many files are formatted to open on standard applications, regardless of the machine. For example, files formatted for the Microsoft® Office® suite of applications may be opened in Office® applications regardless of the computer and the operating system. If the file is a not as-yet complete set of computer code being drafted by a software engineer, it may be opened by any compiler for the language in which it is being coded. Moreover, if someone is preparing for such a misappropriation of files, files may also be saved in formats which allow them to be opened in a variety of applications on a variety of operating systems. For example, a .txt format file can be opened on nearly any machine worldwide.

The remedies for misappropriation of files are few. Often, the remedy involves a protracted legal battle. Some contemporary measures are available to prevent a misappropriation of proprietary information, to include computer files, but these measures are expensive and cumbersome. Companies would likely prefer to prevent the loss of files, which very well might contain trade secret, or at a minimum, proprietary information, as a lower cost solution than to deal with the consequences of misappropriation. Prevention of the loss of files is much less expensive than a protracted legal battle. Such legal battles may be lost even before they're begun. That is, if the trade secret becomes public, a company cannot put the genie back in to the bottle. No matter how well the litigation goes, the trade secret is lost. Even if the company can get an injunction against the competitor's use and money damages, the long-term harm done to the company by the disclosure of the trade secret may be greater than, and therefore cannot be fully cured by, the injunction and damages.

For the foregoing reasons, there is a need for a local file security system that will prevent the removal of files or computing systems and the use of the file or computing system outside of the owning company.

### SUMMARY

Disclosed is a system for local computer file security. The system may include a script attached to an encrypted file on a local computing device. The script may include a first subroutine, a second subroutine, and a third subroutine. The first subroutine may include instructions which determine a first CPUID of the machine on which the file is being opened. The first subroutine may further compare the first CPUID against a second CPUID stored in memory by the script to determine if there is a match. The first subroutine may record the result of the CPUID comparison. The second subroutine may include instructions which may obtain a first set data by interrogating a plurality of locations. The second subroutine may further include comparing the first set of data with a second set of data stored in memory, the second set of data indicating the file is being opened on a virtual machine. The second subroutine may further record the result of the comparison. The third subroutine may include instructions which may place the recorded results of the first and second subroutines in a message. The system may include an encryption routine which may encrypt the message. The system may further include a communication protocol which may send the message. The system may further include a company server including a memory, the company server may be electrically connected to the local computing device without any intervening servers. The company server may include a copy of the communication protocol. The system may further include an executable file which may be stored on the memory. The executable file may include instructions which may decrypt the message and check the results of the first and second subroutines. If the results indicate that the CPUIDs matched, and the file was not being opened on a virtual machine, then the system may perform an intermediate server check. If the results indicated that either the CPUIDs didn't match, or that the file was being opened on a virtual machine or both, then the company server may return a message to the local computer that the file cannot be decrypted. The intermediate server check may include a review of the message to determine if the message includes any artifacts indicating that the message passed through another server before arriving at the company server, and if the message does not include any artifacts, the company server may encrypt a message including data that will decrypt the file, or, if the message is determined to include artifacts indicating the message passed through another server, the company server may return a message indicating that the file cannot be decrypted.

Also disclosed is a method for providing local file security. The method may include determining a first CPUID of a machine opening the file. The method may further include comparing the first CPUID to a second CPUID stored in a script on the file. The method may interrogate a first set of data in a plurality of memory locations on the machine opening the file to find artifacts of a virtual machine. The method may compare the first set of data to a second set of data stored in a memory by the script, the second set of data including artifacts indicative of a virtual machine. The method may place results of the comparison in a message for sending to a company server. The local machine may encrypt the message. The method may include sending the message to the company server, and the company server may decrypt the message on the company server. If the results are a match for the CPUID and not a match for the virtual machine, the company server may check the message header to determine if the message has passed through an outside server before arriving that the company server. If the results are not a match for the CPUID or a match for the virtual machine, or both, the company server may send a message to the local machine causing a message saying the file cannot be decrypted to display. If the message has not passed through an outside server before the company server, the company server may send an encrypted message to the local machine with instructions which decrypts the file.

Also disclosed is a system for maintaining local file security. The system may include a local machine including a first memory and a processor. The system may further include a script attached to a file stored on the memory, the script may include instructions for execution on the processor. The instructions may include a first part of a check which may find a first CPUID of a machine on which the file is being opened and may compare the first CPUID to a second CPUID stored in the script. If the first CPUID matches the second CPUID, then the check is passed and the script may record the result, if the first CPUID does not match the second CPUID, then the check is failed and the script may record that result. A second part of the check may review a plurality of memory locations on the local machine for artifacts indicating the machine is a virtual machine. The script may compare a first set of data found in the plurality of memory locations to a second set of data stored in the script, and may record the result. If any of the first set of data from the plurality of locations matches any of the second set of data then the check is failed and the result may be recorded. If none of the first set of data matches any of the second set of data, then the second part of the check is passed and the result may be recorded. A third part of the check which may determine if either of the first part of the check or the second part of the check was failed. If either or both of the first part of the check and second the second part of the check were failed, then displaying text stating that the file cannot be decrypted. If the first part of the check and the second part of the check are both passed, then the script may encrypt and may send a first message to a company server. The company server may include the information that both the first part of the check and the second part of the check were passed. The company server may include an executable file stored on a second memory, and a processor for executing instructions from the executable file. The instructions may include a first set of instructions which may receive and decrypt the message. The instructions may further include a second set of instructions which may check the message to determine if the message passed through another server before arriving at the company server. The instructions may further include a third set of instructions which, if no indications of the first message passing through another server before arriving at the company server were found, may create an encrypted second message including instructions to decrypt the file, and may cause the encrypted second message to be sent to the local machine. The instructions may include a fourth set of instructions which, if an indication of the first message passing through another server before arriving at the company server is found, then the instructions may cause a third message to be sent to the local machine. The third message may cause text to be displayed stating that the file cannot be decrypted.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic view of a system for local computer file security.

FIG. 2 shows an example method of a security check of a plurality of subroutines.

FIG. 3 shows an example method of receiving a message from the local computing device and decrypting the message using a public and company server private key.

### DETAILED DESCRIPTION

The detailed description set forth below in connection with the appended drawings is intended as a description of the presently preferred embodiment of a system and method to provide security for locally stored files, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

The security of local files must address the insider threat, which is the recognized greatest threat to theft of intellectual property via computer files. Computer files in everyday use at a company may include spreadsheet files, presentation files, word processing files, and files of computer code in the process of being written. Each of these files may contain trade secret information, proprietary information, or even patentable subject matter. If such files were to be misappropriated by an insider, considerable damage could be done to the company, including loss of trade secrets and a bar to patenting inventions contained in the files. The best solution is to maintain control and security of such files against an insider threat.

The heart of the security of the disclosed locally stored file security system and method consists of a security check of three parts. All three parts are contained within a script which automatically runs when the file is opened. The first part is for the script to check that the central processing unit identification (CPUID) of the computing device on which the file is being opened is the same as that stored in the script. The second part is that the script also checks that the file is not being opened on a virtual machine. The final part is only in part executed by the script, and for this third check or subroutine, the script asks a server if the local computing device is directly connected to the server, without any traffic passing through any intermediate servers. If any of the three parts is failed, then the file remains encrypted. The files may only be decrypted through a public key encryption scheme when connected directly to a company server.

The CPUID check is one way to determine that the file is running on a specific local machine. Each computer has a central processor. The central processors are given individual serial numbers by the processor manufacturers. When the file is created, the script checks for the serial number, or CPUID, of the processor, and stores that number within the script. Later, when the script is running a check prior to again opening the file, the script checks the CPUID again and compares the just obtained CPUID to the one stored in the script. If the two CPUIDs match, the check is passed, and the script moves on. If the two CPUIDs do not match, the check fails, and the file is not decrypted and opened.

The script next checks several places to determine if the machine on which the file is being opened is a virtual machine. This check is included in the system and method to counter the fact that the physical CPUID number of a local machine may be spoofed on a virtual machine. Without this check, if files were transferred to an external storage device, for example, a portable hard drive, the individual or organization misappropriating the files may create a virtual machine which will provide the same CPUID as the actual machine on which the file was created. However, if virtual machine artifacts are found during this second part of the check performed by the script, the check is failed, and the file is not decrypted and opened on the local machine. In contrast, if no virtual machine artifacts are found, this second part of the check is passed and the script moves on to the third part. The third part may also be called the third check or the third subroutine.

The third part of the check includes providing instructions to a company server to determine if the message sent to the company server include packet header data which would indicate that the test message has passed through other servers before arriving at the company server. This indicates that the local machine has been removed from the company premises and someone is attempting to connect the machine from a remote location. The script asks the server to determine if such artifacts from other servers exist within the packet header. After performing the check, the company service provides an answer. If there are no packet header artifacts, then this part of the check is passed, and the file is decrypted and opened. If the header packet or other part of the message is found to include at least one artifact from another server, then the check is failed and the file is not decrypted or opened on the local machine.

More specifically, the system and method operates to improve the security of locally stored files by including a script with every file created by a user. When a user creates a new file within an application, either by selecting a “new file” option from a dropdown menu, or otherwise creates a new file, in the background a local file security module attaches a script to that file. The script is written ahead of time and attached to the file automatically when the file is created. For example, with a .docx file, the file may be treated as a .zip file, and the script added, and then the file converted back to a .docx file. The script file will be embedded in the .docx file. Other types of files may have the script embedded in a similar or another manner. Regardless of the precise method, attaching scripts to another file is well known in the art, and may be accomplished by one of any of the known methods. The file may have a second script attached. This second script corrupts the file if the first script containing the checks or the second script itself are tampered with. For example, if a misappropriator attempts to delete any of the scripts in order to bypass the checks and gain access to the file.

The file is further automatically encrypted. The script may use an operating system's built in functions to encrypt the file. The script may obtain the password provided by the operating system, while the user being unaware of both the process of encryption and the password number. Alternatively, the file may be encrypted by an encryption scheme embedded in the script itself. The password or key to decrypt the file may be passed to the company server. In order to provide greater security, the password or key to decrypt the file is not stored on the local machine or local computing device.

The messages passed between the local machine and the company server may be encrypted using a public key encryption scheme, for example, an asymmetric encryption scheme. In an asymmetric encryption scheme, the local computing device has a private key, and the company server has a private key. The local computing device and the company server share a public key to pass information between them, but only the private key on either the local computing device or the company server. The file on the local computing device may send information contained in an encrypted message to the company server. The information may include the results of the check.

The company server may decrypt the incoming message and thereby obtain the results of the check. The company server may compare the results from the message with results stored in a memory on the server. If the results do not match, the server may send a return message to the local computing device. The return message may include instructions to display a message to the user that the check was failed, and the file remains encrypted.

Alternatively, if the comparison of the results from the message matches the results stored on the memory of the company server, then the company server may return a message including a key or a script which includes a key to decrypt the file stored on the local computing device. If the company server only returns a key, the script included with the local file may include instructions for using the key to decrypt the file. Alternatively, the company server may send a script to the local computing device. The script may include instructions for decrypting the file on the local computing device.

Once the file is decrypted, it may be used normally. For example, the file may be edited and saved the way any other file of the same type, but not including the encryption script, may be edited and saved. The encryption only affects access to the file, the script and the encryption do not affect the operation of the file once a check has been passed. “Passing” the check is defined as the messaged check results matching the results stored on the company server memory when the two are compared. Once such a check is passed, full access to the file and its parameters is granted.

When the file is closed, or the local computing device is turned off, or the local computing device goes to sleep, another check must be performed and passed to gain access to the file. Such an additional check ensures security of the file because it may be possible for a misappropriator to open the file after passing the check, and then remove a mobile local computing device, such as a laptop, while the file is still open. The user may close the laptop and disconnect from the network, move to a remote location, and awaken the device, and have the file still open. However, because the user closed the laptop, the local computing device was put to sleep, and the file must be unencrypted before additional use. Of course, additional precautions must be taken by the company to either check for, or prevent users adding software to their local computing devices which may subvert such a security scheme. For example, software is made that will prevent a laptop from going to sleep when the laptop is closed.

Further, if a machine is not disconnected from a network using a particular protocol, the machine may be either automatically remotely encrypted or automatically remotely wiped by the company server. Alternatively, remote encryption or remote wiping may be manually implemented by a network administrator. Each option may be effective in conjunction with the disclosed local file security system.

Also, typical anti-malware programs may prevent the script from running, so malware checks may have to be moved to a server-level option, or some measure of additional risk accepted due to the anti-malware software being removed from the local machine. With the server performing malware checks, service processing power and speed may be affected. Thus, it may be necessary to increase the processing power of each of the servers used by a company to compensate for the changes.

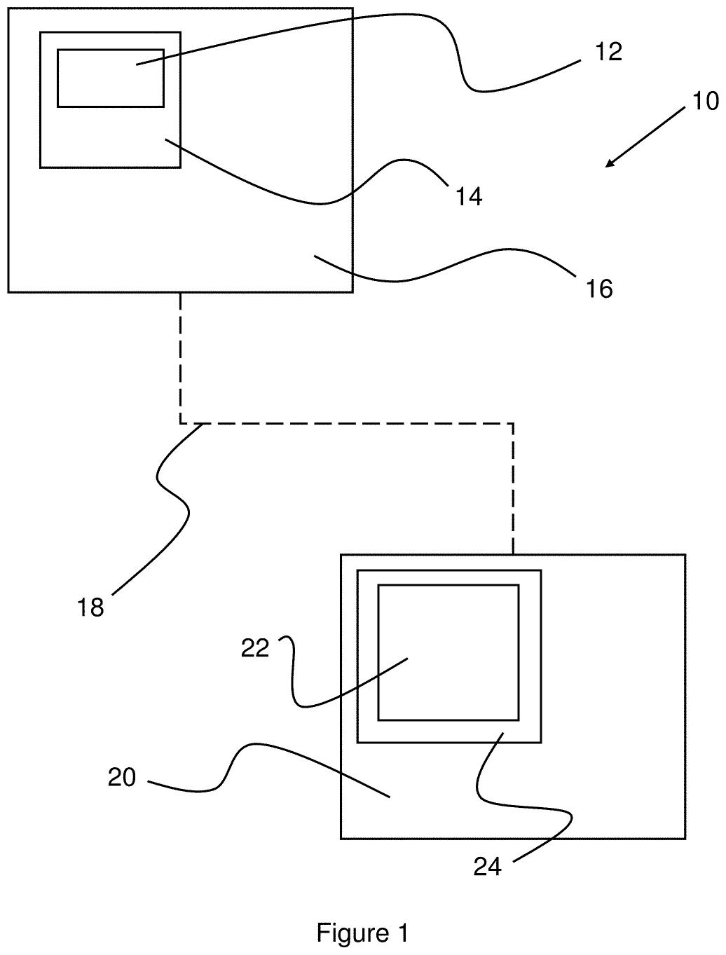

Thus, as is shown in FIG. 1, in terms of physical arrangement, the system 10 includes one or more scripts 12 installed on a local file 14 of one or more types saved to a memory of a local machine 16 or computing device. The local machine 16 is connected via a wired or wireless network, or a combination of both 18, to a company server 20. The company server 20 has at least one local file security executable file 22 saved on to a memory 24 of the company server 20.

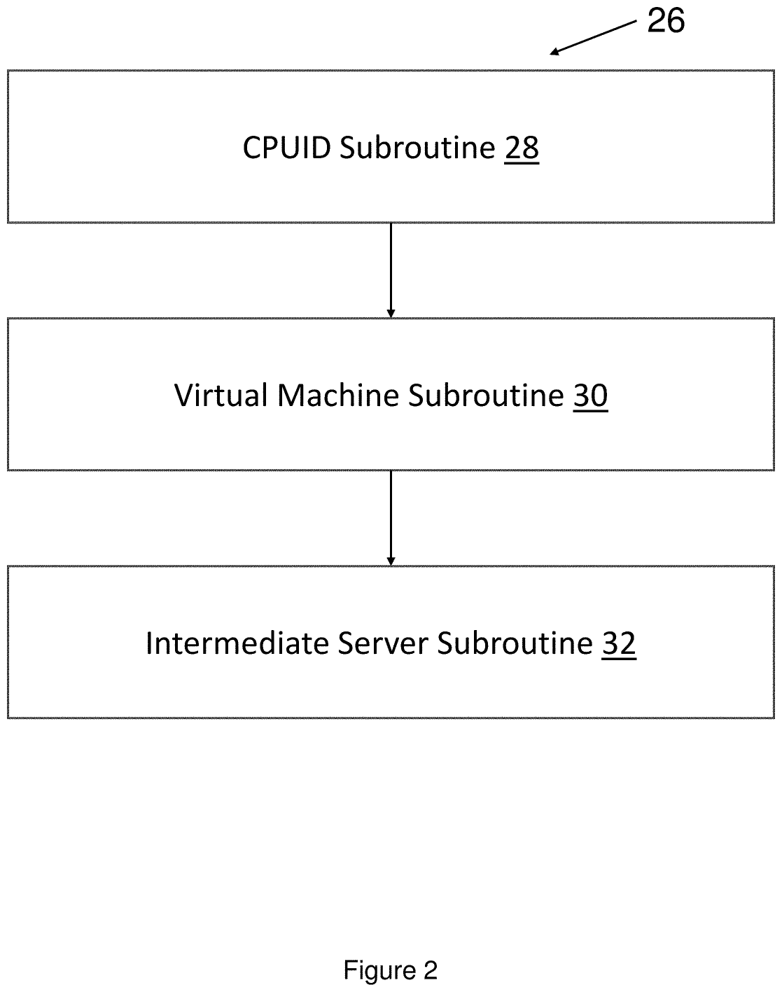

With reference to FIGS. 1 and 2, the script 12, as part of the local file 14, includes a check 26. The check may include three parts or subroutines. The first subroutine 28 may obtain the CPUID of the local computing device, and may compare the CPUID to another CPUID stored in the script when the file was created, and store the result of the comparison in a message for sending to the company server. The second subroutine 30 may check a plurality of locations on the local machine for artifacts that would indicate that the machine on which the file 14 is being opened is a virtual machine. The second subroutine 30 stores in the same message containing the result from the first subroutine 28 whether there is a positive result, that is, that the second subroutine 30 found at least one artifact indicating that the file 14 is being opened on a virtual machine, or a negative result, that is, that the second subroutine 30 did not find any artifacts indicating that the file 14 was being opened on a virtual machine.

The third subroutine 32 may occur on the company server 20 side, because the third part or subroutine 32 requires the analysis of a message passed from the local machine 16 to the company server 20 to determine if the message has passed through one or more intermediate servers. Thus, no result for this third part or subroutine 32 is included in the message sent to the company server 20. Rather, the creation of the message enables the execution of the third part or subroutine once the message reaches the company server 20.

The script 12 may further include instructions to send the message or data for the message to a protocol module. The protocol module may format the message according to one of a number of well know network protocols. For example, the message may be sent using a WiFi® protocol, or a Bluetooth® protocol, or any of a number of other protocols known in the art. The protocol module may further include instructions for the sending the message or data to an encryption protocol. The encryption protocol may encrypt the message according to an asymmetric encryption protocol. Thus, the message may be encrypted using a public key, and may only be decrypted using the company server's private key. Once the message is encrypted and formatted per the network protocol, it may be sent to the company server 20.

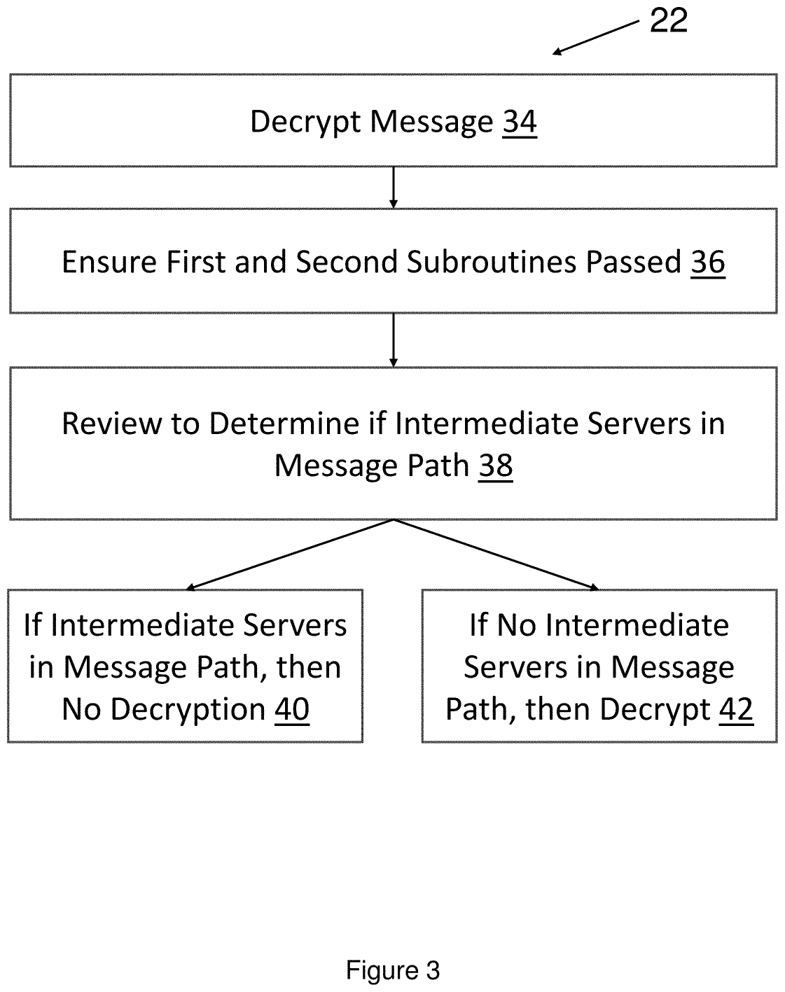

As shown in FIG. 3, the company server may include an executable file 22, which receives the message from the local computing device, and decrypts the message 34 using the public and company server private keys. The public key is used to encrypt the message during transmission, but the message may only be decrypted using the private key of the company server. Once the message is decrypted, the company server may ensure 36 that the first two parts or subroutines of the check have been passed. The executable program on the company server may do so through a review of the data included with the message. The company server may then perform the third part or subroutine. Specifically, the executable program may review 38 the header packet of the message to determine if the message has been through an intermediate server. In Step 40, if there are markers in the packet indicating that the message has been through another server, the company server may a message that the file cannot be decrypted. In contrast, in Step 42, if the review of the message determines that the message has not been through another server, the company server may add information to a return message that will decrypt the file on the local computing device.

Alternatively, the local computing device may not send a message if either of the first two checks are failed. The script may include instructions that prevent any communication with the company server if either of the first two subroutines of the script returns a failed result. The script may include a check before any message is sent to the company server, and, if there is a negative result from either of the two first subroutines, then the script includes instructions to not send the message to the company server. Instead, the script may include instructions that cause the local computing device to display a message to a user of the local computing device that the file cannot be decrypted. The instructions in the script may further prevent any further action on the file, effectively locking the file. The instructions may require that the file must be close and

In operation, the system and method start with the creation of any file on a local machine. A local machine may be a laptop, a tablet computing device, or even a desktop computer. Local machines are differentiated from servers, as local machines are meant to meet the needs of a single user. When a file of any type is created by a user and first opened for use, the local machine attaches a script to the file. The type of file may be a word processing document. The file may also be a spreadsheet. The file may be a presentation document, for example, the file could be a Microsoft® PowerPoint® file. The file may also be a database. The file may be a compiler, assembler or linker file containing computer code in the drafting process. If the file is a compiler file, the file may be one for a native code compiler, a cross code compiler, a source to source compiler, an incremental compiler, or a source compiler. The compilers may be for a number of languages, for example, C, C++, and Java. If the file is an assembler file, the assembly language may be that of the host machine, or a non-hosted machine. If the file is a linker file, it may be either a static or dynamic linker. Thus, the file may be any of hundreds of files typically created on a local machine by a user.

The script may automatically encrypt the file. The script may use an operating system's built in functions to encrypt the file. The script may obtain the password provided by the operating system, while the user being unaware of both the process of encryption and the password number. Alternatively, the file may be encrypted by an encryption scheme embedded in the script itself. The password or key to decrypt the file may be passed to the company server. In order to provide greater security, the password or key to decrypt the file is not stored on the local machine or local computing device.

Contemporaneously, as soon as the file is created, the script will attach to the file and may automatically check the CPUID of the machine. Once the CPUID of the machine is determined, the script may record the CPUID in the script. Once the CPUID is recorded, the script may use the recorded CPUID to compare to the retrieved CPUID when the file is opened in the future. In order to obtain the CPUID, the script may have code, or instructions, which interrogates or calls the CPUID. As is well known in the art, the CPUID opcode is 0Fh, A2h (as two bytes, or A20Fh as a single word). In assembly language, the CPUID instruction takes no parameters as CPUID implicitly uses the EAX register to determine the main category of information returned. In Intel's more recent terminology, this is called the CPUID leaf. CPUID should be called with EAX=0 first, as this will store in the EAX register the highest EAX calling parameter (leaf) that the CPU implements. To obtain extended function information CPUID may be called with the most significant bit of EAX set. Thus, in order to determine the highest extended function calling parameter, CPUID may be called with EAX=80000000h. CPUID leaves greater than 3 but less than 80000000 are accessible only when the model-specific registers have IA32_MISC_Disab1E.BOOT_NT4 [bit 22]=0. As the name suggests, Windows NT4 will not boot properly unless this bit is set, but later versions of Windows do not need it, so basic leaves greater than 4 can be assumed visible on current Windows systems. As of July 2014, basic valid leaves go up to 14 h, but the information returned by some leaves are not disclosed in publicly available documentation, i.e. they are “reserved.” Some of the more recently added leaves also have sub-leaves, which are selected via the ECX register before calling CPUID.

In addition to the CPUID check, the script may perform other checks upon creation of the file. The script may cause the local machine to send a message to the company server with data requiring a security check of the message. A check of the message header is required to determine the company server is connected to the local machine directly. The one or more executable programs on the company server may review the message, including, but not limited to, the message header packet, to determine if the message has passed through any other server prior to the company server. These servers through which the message may have passed may also be called intermediate servers because they are located in a message path between the local machine and the company server. If the review of the message by the one or more executable programs does not find any evidence of the message having passed through any intermediate servers, then the one or more executable programs may place data in a message that the file may be made fully functional. The local machine may receive the message and provide the data to the script. The script may then allow full functionality of the file. Before the script receives the data indicating that the file may be made fully functional because the local machine is directly connected to the company server, the file may have functionality limited to formatting and saving. If the company server finds evidence that the message has passed through any intermediate servers, then the company server may cause a message to be sent to the local machine. The message sent to the local machine may cause a message to be displayed to the user which states that the file cannot be opened, and the local machine, through the script, may automatically close the file without saving any contents of the file.

Once the CPUID is stored in the script and the local machine is determined to have a direct connection to the company server, the script is ready to initiate when the file is reopened. The data to which the potential virtual machine artifacts from the plurality of memory locations is compared is automatically populated in the script when the script is created. Further, the instructions for encrypting a message with the results of the above checks and sending the message to the company server are also a pre-programmed part of the script. Thus, once the CPUID is stored in the script, the script is ready to execute any time the file is reopened by a user. The script does not perform continuous checks, but is rather event driven, detecting changes in the way the system is connected or the condition of the local machine until the file is closed.

After the file is created and closed, a user may choose to reopen the file to edit the file, to print the contents, or perform any of a number of possible actions with the file. When the file is opened, the script automatically runs. First, the script may run the CPUID subroutine. That is, in a first step, the script may execute instructions on the processor of the device that determine the CPUID of the machine on which the file is being opened. However, once the CPUID is obtained during the opening of a previously created file, the determined CPUID is not stored, but rather, in a second step, the determined CPUID is compared to the CPUID stored during the creation of the file. In a third step, if the CPUID of the machine on which the file is being opened matches the CPUID stored in the script, the script records that the CPUIDs match. The recordation may be binary. That is, the script may simply record that the subroutine is passed or failed. If the CPUID of the machine on which the file is being opened does not match the CPUID stored in the script, then the script records that the CPUIDs do not match. Again, the recordation may be binary. That is, the script may simply record that the subroutine is passed or failed. Specifically, in these circumstances, the script may record that the subroutine is failed. Next, the script may move on to the next subroutine. Alternatively, if the comparison determined that the CPUIDs do not match, the script may include instructions which cause a message to be displayed to the user that the file cannot be decrypted. The process ends after the message is displayed, and the user has to reinitiate the process by attempting to open the file again.

The script next performs the second part of the check, or runs the second sub-routine. The second part of the check or second subroutine may, in a first step, interrogate a plurality of memory locations on the local machine and record what the script finds in the plurality of memory locations. The plurality of locations may include performing a check which obtains the same data the user would obtain if the user checked the hardware of the machine, for example, through a check of the control panel on a Windows® operating system. Similarly, the script may obtain data that would be the same data if the user typed “SYSTEMINFO” in a Windows® CMD window. The script may also obtain the data which would be obtained from an extended “SYSTEMINFO” command, specifically, a “systeminfo findstr/i model.” The script may also include instructions that would obtain the data a user would obtain if the user entered the command “gwmi -q “select * from win32_computersystem” in a powershell. The script may also obtain the data the user would obtain if the user were to enter the command “wmic/node: bios get serialnumber” from a powershell session. The script may further determine all of the running processes on the local machine. On a virtual machine, there will be many indicators of virtual machine processes. The script may also obtain information similar to that which would be obtained on a Linux system using “virt-what.”

The information obtained in the first step may be stored by the script in memory. In a second step, the information obtained and stored may be compared to data stored in the script indicative of a virtual machine. The comparison is performed on a specific data type to specific data type basis. Thus, the data obtained is compared to data stored in the script, and the data stored in the script is representative of data that may be obtained from virtual machines using the exact same techniques as the second subroutine.

The data stored in the script indicating the presence of a virtual machine may be updated from time to time. As operating systems evolve, where these systems store information may change. Moreover, the script may have to be adapted for different or for multiple operating systems. If the script is adapted for multiple operating systems, then it can still provide security even if the file is created on a first operating system, and then later, the same machine is migrated to a different operating system. In addition, if the data indicative of a virtual machine change, those individual entries may need updating for the script in order to function properly, that is, not provide false positives, or indications of a virtual machine when there is not a virtual machine, and to provide correct identification of a virtual machine when one is present.

The script then compares the data found on the local machine to the data indicative of the presence of a virtual machine stored in memory and recalled by the script. If, during the comparison, the script determines that any of the data found on the local machine matches any of the data indicative of the presence of a virtual machine, then the part of the check or subroutine is failed and that result recorded. As with the first subroutine, the result recorded may be binary. That is, the result may be recorded as “pass” or “fail.” If the data found on the local machine does not match any of the data indicative of the presence of a virtual machine, then the check or subroutine is passed, and that result is recorded. Again, as with the first subroutine, the result recorded may be binary. That is, the result may be recorded as “pass” or “fail,” and specifically in this case, as “pass.”

After recording the results, the script may move on to causing the results of the second part of the check or subroutine, along with the results of the first check or subroutine to be placed in a message, and the message encrypted and sent to the company server. Alternatively, if any of the data found on the local machine matches any of the data indicative of the presence of a virtual machine stored in memory by the script, the script may include instructions which cause a message to be displayed to the user that the file cannot be decrypted. The script ends the decryption process after the message is displayed, and the file is closed. The user has to reinitiate the process by attempting to open the file again.

The results of the first and second part of the checks or subroutines may be added to a message as data. The script may include instructions which cause the message to be encrypted. Alternatively, the script may include instructions that send the data to another program or set of instructions stored on the local machine, and that program or set of instructions forms and encrypts the message. The local machine then sends the message to the company server. The message may be sent using any of a number of wired or wireless protocols, or a combination of these protocols known in the art. As noted above, if both the first and second parts of the check or first and second subroutines are passed, the message is sent to the company server. Alternatively, the message may not be formed or encrypted if either of the first or second part of the check or first and second subroutines has sent a message to the user stating that the file cannot be decrypted.

The company server may have one or more executable programs which receive and process the message. Once the one or more executable program has received and processed the message to obtain the data within the message, the one or more executable programs may perform further analysis. The one or more executable programs may receive the message and decrypt the message. The one or more executable programs may review the results to ensure that both the first and second parts of the check or first and second subroutines have been passed.

If the review shows that the first and second parts of the check or first and second subroutines have been passed, then the one or more executable programs may perform further analysis. The one or more executable programs may then review the message, including, but not limited to, the message header packet, to determine if the message has passed through any other server prior to the company server. The servers through which the message may have passed may also be called intermediate servers. The term “intermediate” describes these servers location on a message path between the local machine, or computing device, and the company server. If the one or more executable programs does not find any evidence of the message having passed through any intermediate servers, then the one or more executable programs may place data which will decrypt the file on the local machine in to a message. The one or more executable programs may also encrypt the message and cause the message to be sent to the local machine. If the one or more executable programs finds evidence that the message has passed through any intermediate servers, then the one or more executable programs may cause a message to be sent to the local machine. The message sent to the local machine may cause another message to be displayed to the user which states that the file cannot be decrypted. The message may further cause the file to automatically close after the display of the message.

The local machine may perform further operations to allow use of the file. The local machine may receive the encrypted message. The local machine may decrypt the message, and obtain the data sent by the company server. The data sent by the company server may cause the local file to be decrypted, and made available for editing by the user on the local machine. The availability may continue until the file is closed, the computer is shut down, or enters sleep mode, or is disconnected from the local network.

The script may include instructions for changing the functionality or status of the file if the file is closed, the computer is shut down, or the computer enters sleep mode, or if the computer is disconnected from the local network. If the file is closed, then the check and decryption process begins again when the file is opened. However, if the computer is shut down or enters sleep mode, or the computer disconnected from the company server, without instructions from the script requiring otherwise, the file may still be open, and may be open when the local machine is started again, or is brought out of sleep mode, or used “air gapped,” that is, disconnected from the local network. Thus, the script may include instructions which cause the script to check the status of the local machine's network connection. If the computer is disconnected from the network, it may freeze all functionality of the file other than saving and closing. Alternatively, if the local machine is disconnected from the local network, the script may automatically close the file. The check for connection to the network may be performed at predetermined time periods, for example every five seconds. Predetermined time periods of less than five seconds and greater than five seconds are also contemplated.

The script may further include specific instructions for changing the available functionality, or the status, of the open file if the computer is shut down or enters sleep mode. The script may include instructions which change the available functionality, or the status, of the file in a similar manner if the local machine on which the file is open either enters sleep mode or is shut down. The script may include instructions which cause all the functionality, other than saving the file or closing to the file, to be locked when the file is open, and the computer is restarted, or comes out of sleep mode. Alternatively, the script may cause the file to automatically close if the computer is shut down or enters sleep mode with the file open. Such functionality prevents a user from leaving the file open on the local machine and moving the machine to a different location, away from a direct connection with the company server, and continuing to use the functionality of the file, including copying the contents and moving the contents to another file.

Functionality may be restored to the file by reopening the file. The user may simply close the file, if it is not already closed, and reopen the file, causing the script to run and, if the checks are passed, decrypt the file for use. Alternatively, the user may save and close the file, if it is not already closed, and perform other tasks. Even if the user were to create a new file and transfer the contents, the functionality of the script described above will prevent the new file from accepting the copied contents until the local machine is connected directly to the company server.

Below are some nonlimiting example embodiments described above.

In a 1st Example, a system for local computer file security, comprising: a script attached to an encrypted file on a local computing device, the script including a first subroutine, a second subroutine, and a third subroutine, wherein: the first subroutine includes instructions configured to determine a first CPUID of the local computing device on which the file is being opened and to compare the first CPUID against a second CPUID stored in memory by the script to determine if there is a match between the first CPUID and second CPUID, the first subroutine recording a result of the CPUID comparison; the second subroutine includes instructions configured to obtain a first set of data by interrogating a plurality of locations and to compare the first set of data with a second set of data stored in memory, the second set of data indicating the file is being opened on a virtual machine, and record the result of the comparison; the third subroutine includes instructions configured to place the recorded results of the first and second subroutines in a message; an encryption routine configured to encrypt the message; a communication protocol which sends the message; a company server including a memory, the company server electrically connected to the local computing device without any intervening servers and including a copy of the communication protocol; and an executable file stored on the memory, the executable file including instructions which decrypt the message and check the results of the first and second subroutines, if the results indicate that the CPUIDs matched, and the file was not being opened on a virtual machine, then performing an intermediate server check, if the results indicated that either the CPUIDs didn't match, or that the file was being opened on a virtual machine or both, then returning a message to the local computer that the file cannot be decrypted; wherein the intermediate server check includes a review of the message to determine if the message includes any artifacts indicating that the message passed through another server before arriving at the company server, and if the message does not include any artifacts, encrypting a message including data that will decrypt the file, or, if the message is determined to include artifacts indicating the message passed through another server, returning a message indicating that the file cannot be decrypted.

In a 2nd Example, the system of Example 1, wherein the second subroutine includes checking for a mouse and keyboard attached to the local computer.

In a 3rd Example, the system of any of Examples 1-2, wherein the encryption routine is an asymmetric encryption scheme.

In a 4th Example, the system of Example 3, wherein the encryption routine is an S/MIME asymmetric key algorithm.

In a 5th Example, the system of any of Examples 1-4, wherein the script includes instructions which affect an available functionality or status of the file if the local machine is disconnected from the company server, the local machine enters sleep mode, or the local machine is powered off.

In a 6th Example, the system of Example 5, wherein the script automatically closes the file if the local machine is disconnected from the company server, the local machine enters sleep mode, or the local machine is powered off.

In a 7th Example, the system of any of Examples 5-6, wherein the script reduces the functionality of the file to saving and closing if the local machine is disconnected from the company server, the local machine enters sleep mode, or the local machine is powered off.

In a 8th Example, a method for providing local file security, comprising: determining a first CPUID of a machine opening the file; comparing the first CPUID to a second CPUID stored in a script on the file; interrogating a first set of data in a plurality of memory locations on the machine opening the file; comparing the first set of data to a second set of data stored a memory by the script, the second set of data including artifacts indicative of a virtual machine; placing results of the comparison in a message for sending to a company server; encrypting the message; sending the message to the company server; and decrypting the message on the company server; wherein if the results are a match for the CPUID and not a match for the virtual machine, checking the message header to determine if the message has passed through an outside server before arriving that the company server, and if the results are not a match for the CPUID or a match for the virtual machine, or both, sending a message to the local machine causing a message saying the file cannot be decrypted to display; and wherein, if the message has not passed through an outside server before the company server, the company server sends an encrypted message to the local machine with instructions which decrypts the file.

In a 9th Example, the method of Example 8, wherein the interrogating data in a plurality of memory locations on the machine opening the file includes checking the BIOS version to virtual machine indicators.

In a 10th Example, the method of any of Examples 8-9, wherein encrypting the message comprises encrypting the message asymmetrically.

In a 11th Example, the method of any of Examples 8-10, wherein the script automatically closes the file if the local machine is disconnected from the company server, the local machine enters sleep mode, or the local machine is powered off.

In a 12th Example, the method of any of Examples 8-11, wherein the script reduces a functionality of the file to saving and closing if the local machine is disconnected from the company server, the local machine enters sleep mode, or the local machine is powered off.

In a 13th Example, a system for maintaining local file security, comprising: a local machine including a first memory and a processor; and a script attached to a file stored on the memory, the script including instructions for execution on the processor, the instructions including a check, the check including: a first part which finds a first CPUID of a machine on which the file is being opened and compares the first CPUID to a second CPUID stored in the script, if the first CPUID matches the second CPUID, then the first part of the check is passed and the result recorded, if the first CPUID does not match the second CPUID, then the check is failed and the result recorded; a second part which reviews of a plurality of memory locations on the local machine for artifacts indicating the machine is a virtual machine, comparing a first set of data found in the plurality of memory locations to a second set of data stored in the script, and recording the result, if any of the first set of data from the plurality of locations matches any of the second set of data then the check is failed and the result recorded, if none of the first set of data matches any of the second set of data, then the second part of the check is passed and the result is recorded; a third part of the check which determines if either of the first part of the check or second part of the check was failed, and if either or both of the first part of the check and second part of the check were failed, then displays text stating that the file cannot be decrypted, if the first part of the check and second part of the check are both passed, then encrypts and sends a first message to a company server including the information that both the first part of the check and second part of the check were passed; an executable file stored on a second memory on the company server, the company server including a processor for executing instructions from the executable file, the instructions including: a first subset of instructions which receives and decrypts the message; a second subset of instructions which check the message to determine if the message passed through another server before arriving at the company server; a third subset of instructions which, if no indications of the first message passing through another server before arriving at the company server were found, creates an encrypted second message including instructions to decrypt the file, and causes the encrypted second message to be sent to the local machine; and a fourth subset of instructions which, if an indication of the first message passing through another server before arriving at the company server is found, sends a third message to the local machine which causes text to be displayed stating that the file cannot be decrypted.

In a 14th Example, the system of Example 13, wherein the local machine is electrically connected to the company server by a wired or wireless connection, or a combination of a wired and wireless connection.

In a 15th Example, the system of any of Examples 13-14, wherein the second check includes a review of the BIOS information of the local machine.

In a 16th Example, the system of any of Examples 13-15, wherein the encrypting is accomplished using an asymmetric encryption routine.

In a 17th Example, the system of any of Examples 13-16, wherein the file is a word processing document.

In a 18th Example, the system of any of Examples 13-17, wherein the file is a compiler or assembler file.

In a 19th Example, the system of any of Examples 13-18, wherein the script automatically closes the file if the local machine is disconnected from the company server, the local machine enters sleep mode, or the local machine is powered off.

In a 20th Example, the system of any of Examples 13-19, wherein the script reduces a functionality of the file to saving and closing if the local machine is disconnected from the company server, the local machine enters sleep mode, or the local machine is powered off.

The above description is given by way of example, and not limitation. Given the above disclosure, one skilled in the art could devise variations that are within the scope and spirit of the invention disclosed herein, including various ways of forming the transaction number function. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for local computer file security, comprising:
a script attached to an encrypted file on a local computing device, the script including a first subroutine, a second subroutine, and a third subroutine, wherein:
the first subroutine includes instructions configured to determine a first CPUID of the local computing device on which the file is being opened and to compare the first CPUID against a second CPUID stored in memory by the script to determine if there is a match between the first CPUID and second CPUID, the first subroutine recording a result of the CPUID comparison;
the second subroutine includes instructions configured to obtain a first set of data by interrogating a plurality of locations and to compare the first set of data with a second set of data stored in memory, the second set of data indicating the file is being opened on a virtual machine, and record the result of the comparison;
the third subroutine includes instructions configured to place the recorded results of the first and second subroutines in a message;
an encryption routine configured to encrypt the message;
a communication protocol which sends the message;
a company server including a memory, the company server electrically connected to the local computing device without any intervening servers and including a copy of the communication protocol; and
an executable file stored on the memory, the executable file including instructions which decrypt the message and check the results of the first and second subroutines, if the results indicate that the CPUIDs matched, and the file was not being opened on a virtual machine, then performing an intermediate server check, if the results indicated that either the CPUIDs didn't match, or that the file was being opened on a virtual machine or both, then returning a message to the local computer that the file cannot be decrypted;
wherein the intermediate server check includes a review of the message to determine if the message includes any artifacts indicating that the message passed through another server before arriving at the company server, and if the message does not include any artifacts, encrypting a message including data that will decrypt the file, or, if the message is determined to include artifacts indicating the message passed through another server, returning a message indicating that the file cannot be decrypted.

2. The system of claim 1, wherein the second subroutine includes checking for a mouse and keyboard attached to the local computer.

3. The system of claim 1, wherein the encryption routine is an asymmetric encryption scheme.

4. The system of claim 3, wherein the encryption routine is an S/MIME asymmetric key algorithm.

5. The system of claim 1, wherein the script includes instructions which affect an available functionality or status of the file if the local machine is disconnected from the company server, the local machine enters sleep mode, or the local machine is powered off.

6. The system of claim 5, wherein the script automatically closes the file if the local machine is disconnected from the company server, the local machine enters sleep mode, or the local machine is powered off.

7. The system of claim 5, wherein the script reduces the functionality of the file to saving and closing if the local machine is disconnected from the company server, the local machine enters sleep mode, or the local machine is powered off.

8. A method for providing local file security, comprising:
determining a first CPUID of a machine opening the file;
comparing the first CPUID to a second CPUID stored in a script on the file;
interrogating a first set of data in a plurality of memory locations on the machine opening the file;
comparing the first set of data to a second set of data stored a memory by the script, the second set of data including artifacts indicative of a virtual machine;
placing results of the comparison in a message for sending to a company server;
encrypting the message;
sending the message to the company server; and
decrypting the message on the company server;
wherein if the results are a match for the CPUID and not a match for the virtual machine, checking the message header to determine if the message has passed through an outside server before arriving that the company server, and if the results are not a match for the CPUID or a match for the virtual machine, or both, sending a message to the local machine causing a message saying the file cannot be decrypted to display; and
wherein, if the message has not passed through an outside server before the company server, the company server sends an encrypted message to the local machine with instructions which decrypts the file.

9. The method of claim 8, wherein the interrogating data in a plurality of memory locations on the machine opening the file includes checking the BIOS version to virtual machine indicators.

10. The method of claim 8, wherein encrypting the message comprises encrypting the message asymmetrically.

11. The method of claim 8, wherein the script automatically closes the file if the local machine is disconnected from the company server, the local machine enters sleep mode, or the local machine is powered off.

12. The method of claim 8, wherein the script reduces a functionality of the file to saving and closing if the local machine is disconnected from the company server, the local machine enters sleep mode, or the local machine is powered off.

13. A system for maintaining local file security, comprising:
a local machine including a first memory and a processor; and
a script attached to a file stored on the memory, the script including instructions for execution on the processor, the instructions including a check, the check including:
a first part which finds a first CPUID of a machine on which the file is being opened and compares the first CPUID to a second CPUID stored in the script, if the first CPUID matches the second CPUID, then the first part of the check is passed and the result recorded, if the first CPUID does not match the second CPUID, then the check is failed and the result recorded;
a second part which reviews of a plurality of memory locations on the local machine for artifacts indicating the machine is a virtual machine, comparing a first set of data found in the plurality of memory locations to a second set of data stored in the script, and recording the result, if any of the first set of data from the plurality of locations matches any of the second set of data then the check is failed and the result recorded, if none of the first set of data matches any of the second set of data, then the second part of the check is passed and the result is recorded;
a third part of the check which determines if either of the first part of the check or second part of the check was failed, and if either or both of the first part of the check and second part of the check were failed, then displays text stating that the file cannot be decrypted, if the first part of the check and second part of the check are both passed, then encrypts and sends a first message to a company server including the information that both the first part of the check and second part of the check were passed;
an executable file stored on a second memory on the company server, the company server including a processor for executing instructions from the executable file, the instructions including:
a first subset of instructions which receives and decrypts the message;
a second subset of instructions which check the message to determine if the message passed through another server before arriving at the company server;
a third subset of instructions which, if no indications of the first message passing through another server before arriving at the company server were found, creates an encrypted second message including instructions to decrypt the file, and causes the encrypted second message to be sent to the local machine; and
a fourth subset of instructions which, if an indication of the first message passing through another server before arriving at the company server is found, sends a third message to the local machine which causes text to be displayed stating that the file cannot be decrypted.

14. The system of claim 13, wherein the local machine is electrically connected to the company server by a wired or wireless connection, or a combination of a wired and wireless connection.

15. The system of claim 13, wherein the second check includes a review of the BIOS information of the local machine.

16. The system of claim 13, wherein the encrypting is accomplished using an asymmetric encryption routine.

17. The system of claim 13, wherein the file is a word processing document.

18. The system of claim 13, wherein the file is a compiler or assembler file.

19. The system of claim 13, wherein the script automatically closes the file if the local machine is disconnected from the company server, the local machine enters sleep mode, or the local machine is powered off.

20. The system of claim 13, wherein the script reduces a functionality of the file to saving and closing if the local machine is disconnected from the company server, the local machine enters sleep mode, or the local machine is powered off.
